(19) United States
(12) Patent Application Publication
(10) Pub. No.: US 2016/0211667 A1
(43) Pub. Date: Jul. 21, 2016

(54) ASSEMBLY FOR COMPENSATING REACTIVE POWER AND ACTIVE POWER IN A HIGH-VOLTAGE NETWORK

(71) Applicant: SIEMENS AKTIENGESELLSCHAFT, München (DE)

(72) Inventors: HANS-JOACHIM KNAAK, ERLANGEN (DE); MARCOS PEREIRA, ERLANGEN (DE); MARTIN PIESCHEL, NUERNBERG (DE)

(21) Appl. No.: 14/907,343

(22) PCT Filed: Jul. 18, 2014
(86) PCT No.: PCT/EP2014/065475

§ 371 Date: Jan. 25, 2016

(30) Foreign Application Priority Data
Jul. 26, 2013 (DE) 10 2013 214 693.0

(51) Int. Cl. H02J 3/18; H02J 3/32

(52) U.S. Cl. CPC H02J 3/18; H02J 3/32

(57) ABSTRACT

An assembly compensates for reactive power and active power in a high-voltage network. The assembly has a first converter, which is configured for the compensation of active power, and a second converter, which is connected in series and which is configured to compensate reactive power. The voltage that is provided or can be output by the assembly corresponds to the sum of the voltages of the first converter and of the second converter.

The invention relates to an assembly for compensating reactive power and active power in a high-voltage network.

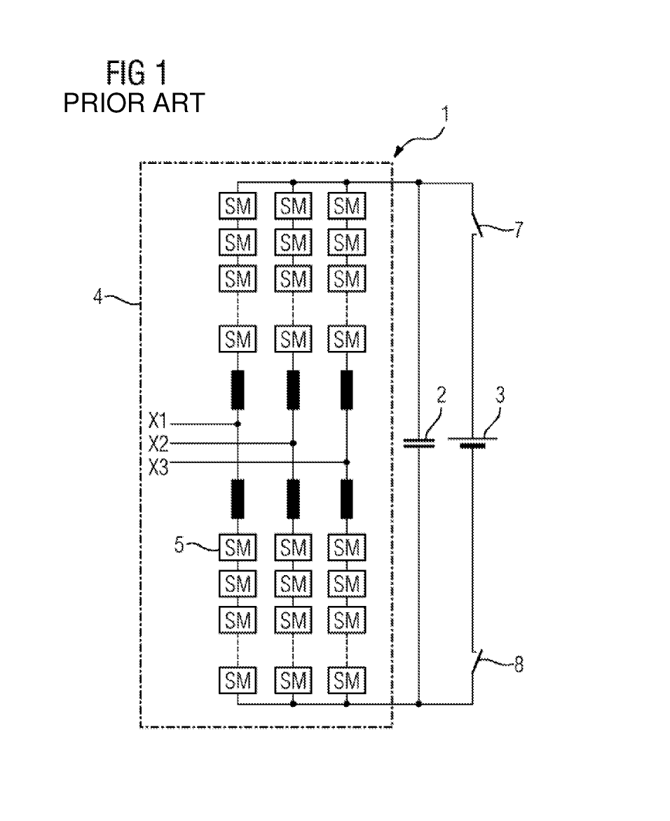

FIG. 1 shows a conventional assembly 1 for compensating reactive power and active power. A capacitor 2 is connected in parallel to a battery 3, whereby these components are connected to the three phases of an a.c. grid system via a converter 4. The capacitor 2 and the battery 3 are connected to the d.c. side of the converter 4. The capacitor 2 compensates reactive power, and the battery 3 compensates active power. For each phase, the converter 4 comprises a number of series-connected submodules 5, in order to achieve the voltage endurance required in a high-voltage system. By means of the switches 7, 8, the battery 3 can be isolated from the remaining components of the assembly 1.

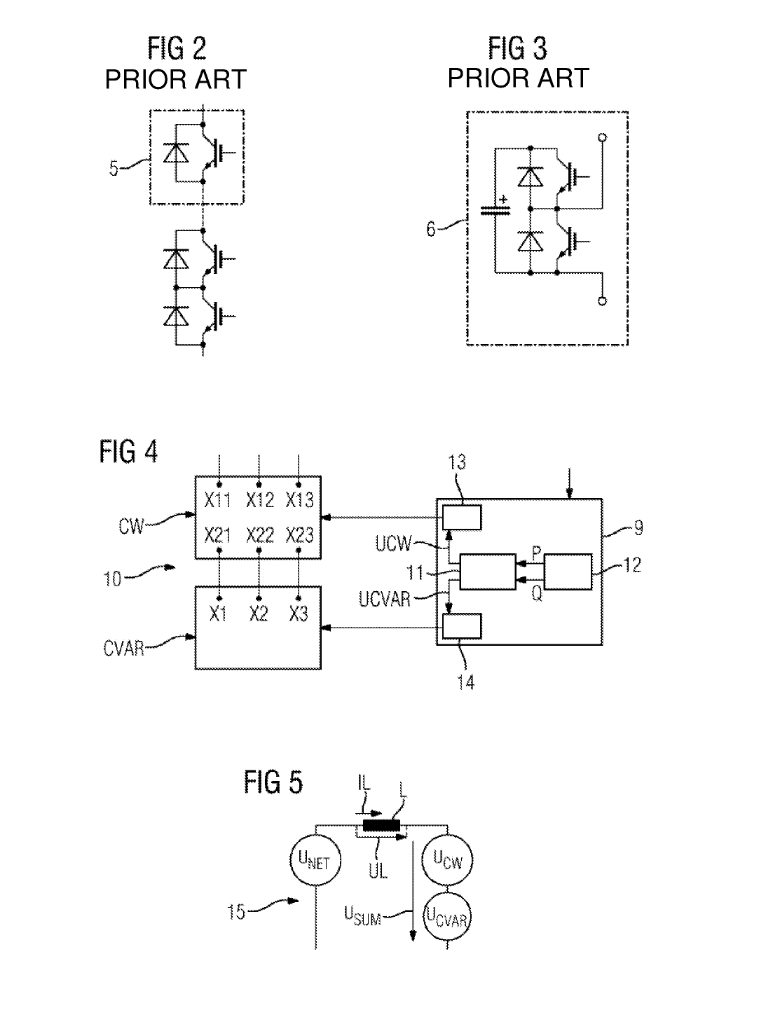

FIG. 2 shows an example of a submodule 5 of this type, comprising a transistor and a diode.

FIG. 3 shows an alternative submodule 6, comprising a half-bridge of semiconductor components and a capacitor.

However, this conventional assembly for compensating reactive power and active power, described with reference to FIGS. 1-3, is associated with a number of problems. If reactive power compensation proceeds in continuous duty, a permanent current flows in the capacitor 2 and the battery 3 which results in heat-up, thereby reducing the service life of sensitive components.

If the voltage on the battery 3 is smaller than the network voltage, an uncontrolled charging current flows through the diodes of the submodules represented in FIGS. 2 and 3. As a result of the high capacity of the energy store, a very high current may flow when the assembly is switched-in with the energy store in the discharged state, thereby resulting in negative consequences for the high-voltage network and for the converter 4.

A further problem arises if, in place of the battery 3, the energy storage elements are configured as double-layer capacitors. Upon the retrieval of stored energy, the capacitor voltage falls by the square root of the voltage. As the voltage on the energy store cannot be smaller than the voltage on the high-voltage network, a substantial restriction in energy output must be accepted. Similar problems occur if a battery is used as an energy store.

Patent publication WO 2010/124706 A1 proposes a modular multi-stage converter, wherein energy storage modules are directly integrated into the individual submodules of the converter. A power electronics unit in the form of a chopper or a voltage converter is used for the connection of an energy store with a submodule. However, the requisite power electronics and the associated choke device result in substantial structural complexity.

The object of the present invention is therefore the proposal of an assembly of simpler design for compensating reactive power and active power in a high-voltage network.

For the fulfillment of the object according to the invention, an assembly of the above-mentioned type is proposed, comprising a first converter, which is designed for the compensation of active power, and a second series-connected converter, which is designed for the compensation of reactive power, whereby the voltage supply or output from the assembly corresponds to the sum of the voltages of the first converter and the second converter.

According to the invention, the problems associated with the prior art are resolved by an assembly with two series-connected converters, whereby the first converter is designed for the compensation of active power, and the second converter is designed for the compensation of reactive power. In the assembly according to the invention, it is essential that the voltage of the converter assembly should correspond to the sum of the voltages of the two converters.

According to the invention, it is preferred that the assembly should comprise a control unit, which is configured for the measurement of voltages and currents present on the high-voltage network, and which determines the voltage outputs from the first and the second converters such that a requisite active power P and a reactive power Q are taken up from the high-voltage network or fed into the high-voltage network.

According to the invention, it is preferred that the control unit should control the two converters, such that the first converter compensates active power only, and the second converter compensates reactive power only.

It also falls within the scope of the invention that the first converter, which is designed for the compensation of active power, comprises as least one energy storage element, or is connected to an energy store. Preferably, the energy storage element may be configured as a capacitor or a double-layer capacitor, or as a battery.

It is preferred that the first converter and/or the second converter should comprise a choke device or devices.

In the assembly according to the invention, the control unit may be configured to control the voltage output of the first converter such that said output is in phase with, or in phase opposition to the current flowing in the converter.

Preferably, it may be provided that the control unit controls the converter which is designed for the compensation of reactive power such that the current flowing in the capacitor is limited.

It also falls within the scope of the invention that the two converters each comprise an H-bridge, which is preferably configured of power semiconductor switches. Preferably, both of the converters are configured as three-phase devices. The converters may be star-connected or delta-connected.

The invention is described hereinafter on the basis of exemplary forms of execution, with reference to the drawings. The drawings are schematic representations, in which:

FIG. 1 shows a conventional assembly for compensating reactive power and active power;

FIGS. 2 & 3 show submodules of the conventional assembly represented in FIG. 1;

FIG. 4 shows an assembly according to the invention for compensating reactive power and active power;

FIG. 5 shows an equivalent circuit diagram of an assembly according to the invention;

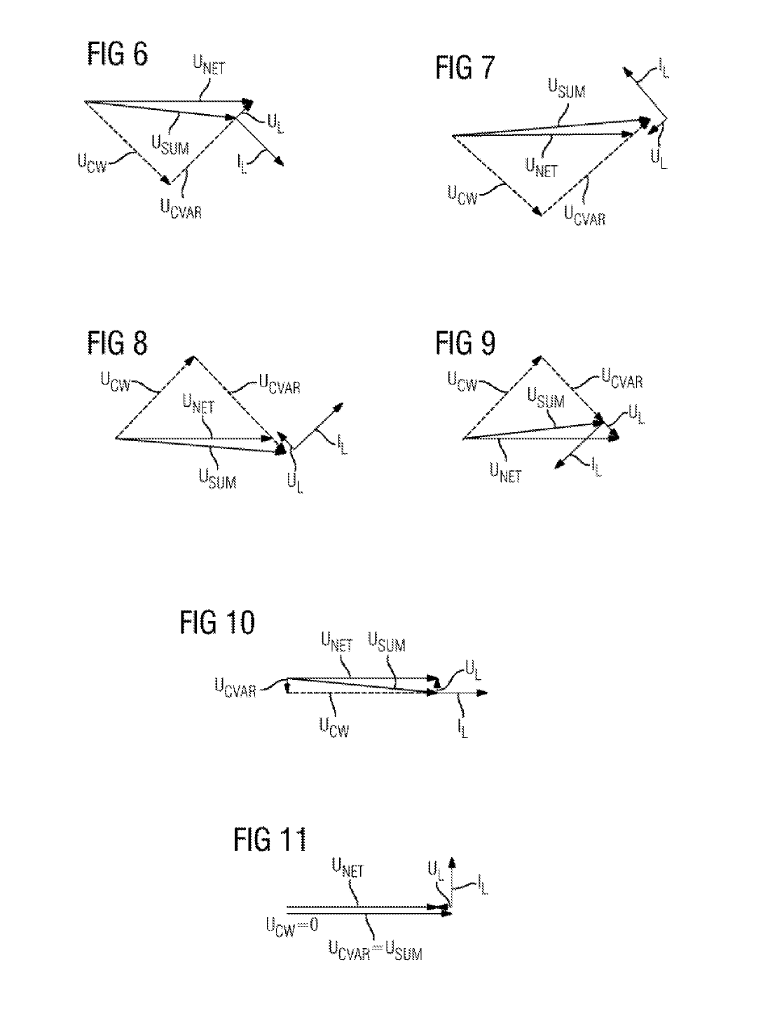

FIGS. 6-11 show vector diagrams of the voltages and currents occurring in the assembly;

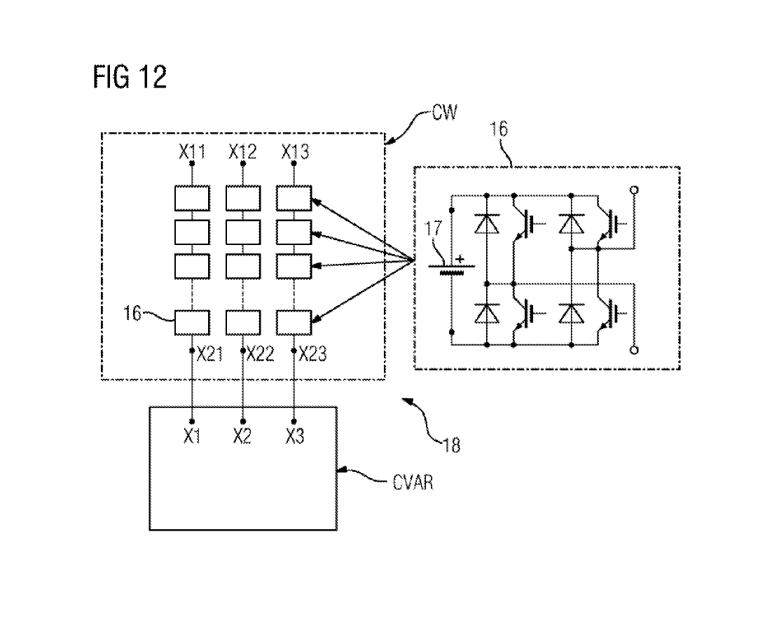

FIG. 12 shows a further exemplary embodiment of an assembly according to the invention for compensating reactive power and active power;

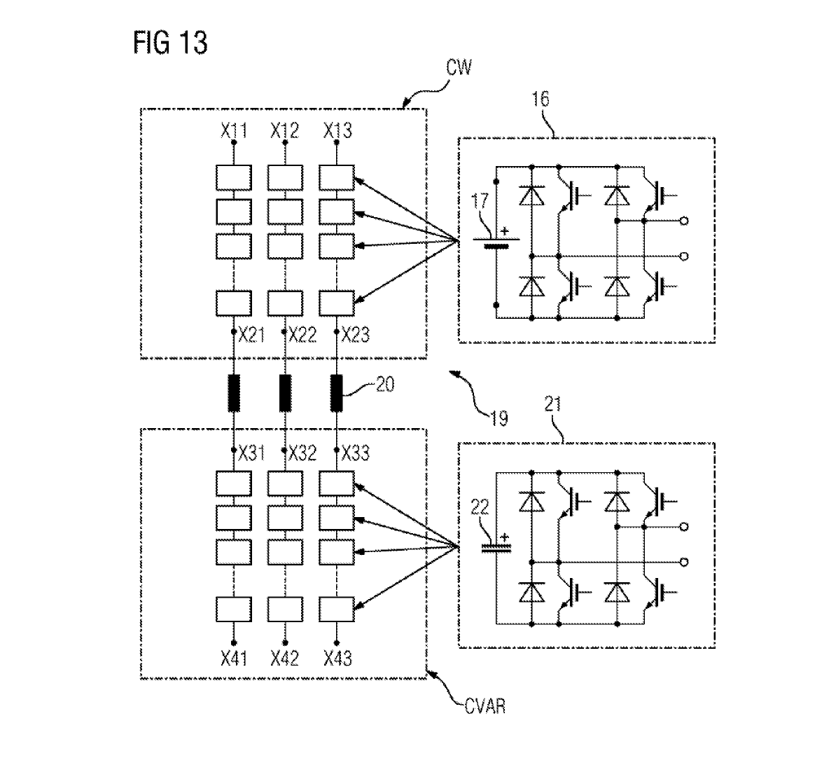

FIG. 13 shows a further exemplary embodiment of an assembly according to the invention for compensating reactive power and active power;

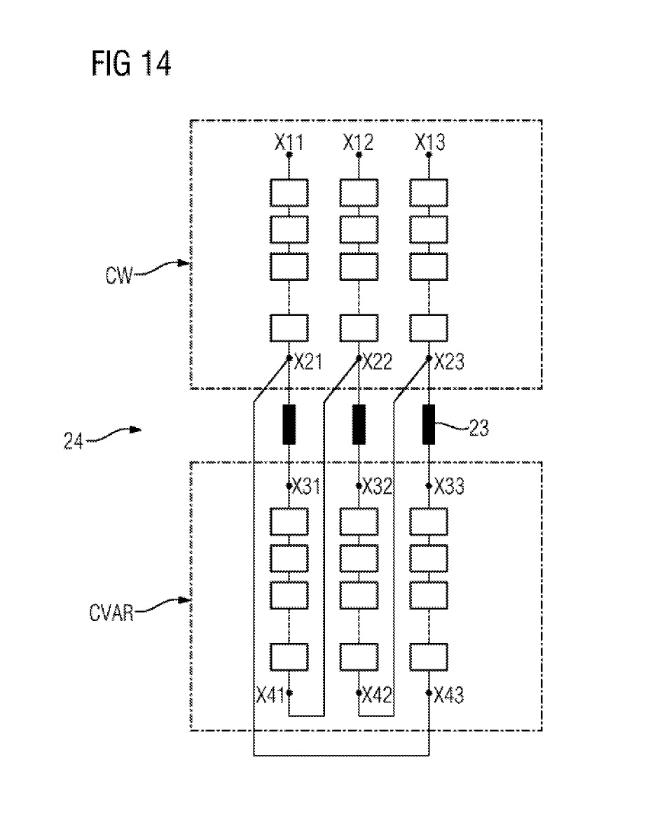

FIG. 14 shows a further exemplary embodiment of an assembly according to the invention for compensating reactive power and active power;

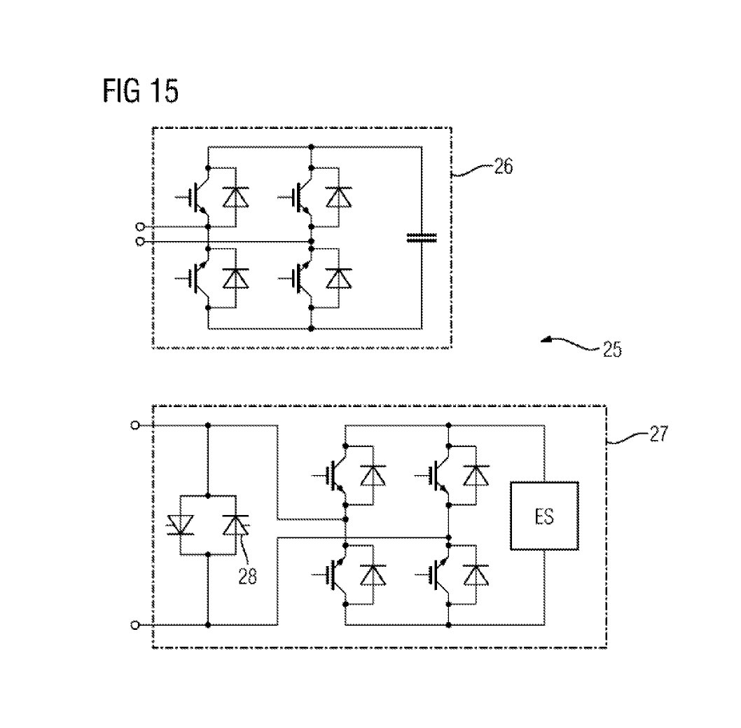

FIG. 15 shows a further exemplary embodiment of an assembly according to the invention;

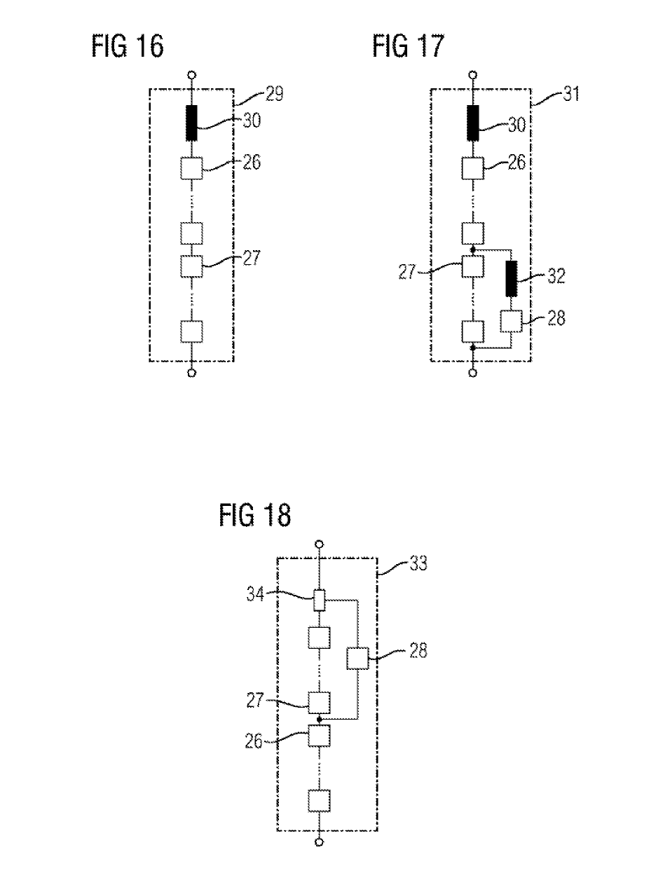

FIGS. 16-18 show further exemplary embodiments of assemblies according to the invention for compensating reactive power and active power, and

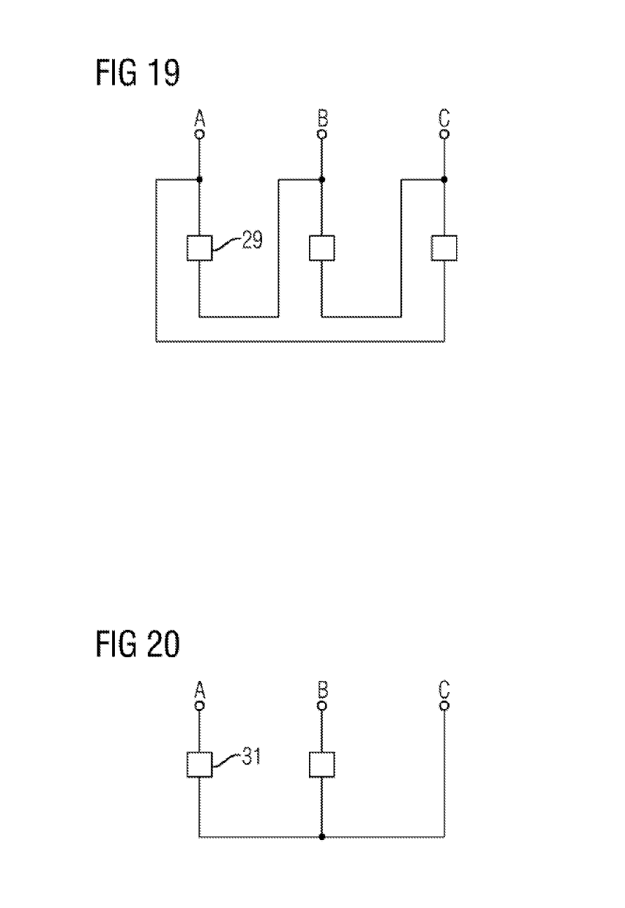

FIGS. 19-22 show applications of the assemblies represented in FIGS. 16-18.

FIG. 4 shows an assembly for compensating reactive power and active power in a high-voltage network, with a first converter CW which is designed for the compensation of active power, and a second converter CVAR connected in series thereto, which is designed for the compensation of reactive power. The two converters CW, CVAR are connected to a control unit 9. The assembly 10 shown in FIG. 4, with the two converters CW, CVAR, may be connected between the phases of the network. Alternatively, branch connections may be provided, such that a delta connection or a star connection with a bonded neutral point is formed.

In the assembly 10, it is essential that the voltage (total voltage) is comprised of the sum of the voltages of the two converters CW, CVAR, whether in the form of individual phase voltages or as a single multi-phase voltage. The converter CVAR is comprised of individual submodules, as in the assembly shown in FIG. 1; however, as only the compensation of reactive power is necessary, neither a battery nor switches are required.

The control unit 9 receives signals corresponding to the electrical variables measured on the high-voltage network.

The control unit 9 is also provided with a controller 12, which is a constituent element of the control unit 9 and which determines the reactive power and the active power which are either taken up by the high-voltage network or fed into the network. A computer 11 calculates the voltages U_{CVAR} and U_{CW} for the converters CVAR and CW, such that the reactive power and active power determined by the controller 12 are converted by the converters CVAR, CW respectively. For each of the two converters CW, CVAR, a converter control unit 13, 14 is provided for the control of the power semiconductor switches.

The operating principle of the assembly 10 is explained with reference to the equivalent circuit diagram shown in FIG. 5. The two converters CW, CVAR and the converter inductance are represented on the equivalent circuit diagram 15 by two voltage sources U_{CVAR} and U_{CW} and by an inductance L. The inductance L is configured as a choke device on one of the converters, or may also be distributed, as an alternative. The total voltage of the converter assembly, i.e. the voltage U_{SUM}, is given by the sum of the voltages from the two voltage sources U_{CW} and U_{CVAR}. The network voltage, i.e. the voltage at the terminals of the assembly, is represented by the voltage source U_{NET}. The voltage U_{L} is the voltage which is generated on the inductance L. I_{L} is the current resulting from the voltages and the inductance in the equivalent circuit diagram 15.

In the description of operation and the control principle, the resistance and the resulting power loss on the inductance L and in the converters CW and CVAR are ignored, as these values are comparatively small.

The following equations are derived from the equivalent circuit diagram 15 represented in FIG. 5, whereby P represents the active power and Q represents the reactive power flowing from the network into the assembly. The abbreviation X_{L} represents the reactive impedance of the inductance L. With the exception of X_{L}, all the variables in the following equations are complex, i.e. they are each comprised of a real and an imaginary component. It will also be evident to a person skilled in the art that U_{NET}, U_{CWr} U_{CVAR}, U_{L} and I_{L} are a.c. voltages and an alternating current, the r.m.s. value of which is considered in the following equations. For the equivalent circuit diagram 15 represented in FIG. 5, the following equations apply:

$${I}_{L} = \frac{P - j Q}{{U}_{NET}}$$

$${U}_{L} = j \cdot {X}_{L} \cdot {I}_{L}$$

$${U}_{SUM} = {U}_{NET} - {U}_{L}$$

If the converter CW is to take up the full active power, and is to contribute to active power only, the voltage U_{CW} must be in phase with the current I_{L}, as I_{L} is also the current flowing in the converter U_{CW}. The voltage U_{CW} is also a component of U_{SUM}. This gives the following equation:

U_{CW}=|U_{SUM}|·cos·[arg(U_{SUM})−arg(I_{L})]·e^{jarg(I}^{_{L}}⁾

This also gives the voltage:

U_{CVAR}=U_{SUM}−U_{CW}.

From the above, it proceeds that the phase difference between U_{CVAR} and I_{L} is 90 degrees and, in consequence, the converter CVAR contributes exclusively to reactive power. Accordingly, an alternative calculation for U_{CVAR} may be applied as follows:

U_{CVAR}=|U_{SUM}|·sin[arg(U_{SUM})−arg(I_{L})]·e^{j[arg(I}^{_{L}}^{)+π2]}

The operation of the assembly for compensating reactive power and active power is described hereinafter with reference to FIGS. 6-11, which are vector diagrams of the voltages arising. In these diagrams, typical values of e.g. U_{NET}=100 kV and X_{L}=100 ohms are assumed. It will be seen that the voltage U_{L} is equal to the difference between U_{NET} and U_{SUM}. The current I_{L} is also represented in the vector diagrams. There is a known and consistent phase lag of 90 degrees between the current I_{L} and the voltage U_{L}. In the examples shown in FIGS. 6 to 11, the network voltage U_{NET} supplies the phase reference in each case, such that the phase value thereof is equal to zero, and the network voltage U_{NET} is therefore represented by a horizontal vector.

From FIGS. 6-9, it proceeds that the voltage U_{CVAR} of a converter CVAR, which is responsible for the compensation of reactive power, is not in phase with the network voltage.

FIG. 6 represents a situation in which the assembly takes up 10 MW of positive active power and 10 MVAR of reactive power. Considered from the network, the assembly constitutes a resistance and a choke device accordingly. As already mentioned, the phase lag between the current I_{L} and the voltage U_{L} is 90 degrees. The voltage U_{CW} is in phase with I_{L}, as the active power is positive. The phase lead between the voltage U_{CVAR} and the current I_{L} is 90 degrees, as the reactive power is positive.

FIG. 7 represents a situation in which the assembly delivers 10 MW of negative active power and 10 MVAR of positive reactive power. Accordingly, the assembly functions as a generator and a capacitor. The voltage U_{CW} is in phase opposition to I_{L}, and the phase lag between the voltage U_{CVAR} and I_{L} is 90 degrees.

FIG. 8 represents a situation in which the assembly takes up 10 MW of positive active power and delivers 10 MVAR of reactive power such that, considered from the network, the assembly constitutes a resistance and a capacitor. The voltage U_{CW} is in phase with I_{L}, and the phase lag between the voltage U_{CVAR} and the current I_{L} is 90 degrees.

FIG. 9 represents a situation in which the assembly delivers 10 MW (negative active power) and takes up approximately 10 MVAR, as a generator and a choke device. The voltage U_{CW} is in phase opposition to I_{L}, and the phase lead between the voltage U_{CVAR} and I_{L} is 90 degrees.

FIG. 10 represents a specific situation, in which the assembly takes up active power only. Accordingly, the voltages U_{NET}, U_{CW} and the current I_{L} are in phase with each other. U_{NET} and U_{CW} are also of equal value. The converter CVAR equalizes the reactive power on the choke device L with its voltage U_{CVAR} and regulates the active capacity of the assembly.

FIG. 11 represents a specific situation, in which the voltage U_{CW} on the converter CW is zero. Accordingly, the assembly delivers no active power, U_{CVAR} and U_{NET} are in phase, and show a phase lag in relation to I_{L}. In this example, the reactive power is negative and, considered from the network, the assembly constitutes a capacitor.

The first of the above-mentioned problems, namely, the permanent loading of the energy store by reactive power, is resolved by the assembly in that the converter CW, to which the energy store is connected, contributes to the active power element only, such that its voltage U_{CW} can be maintained at a low value, if not zero, whereas the converter CVAR compensates reactive power. Accordingly, in continuous duty, the energy store on the converter CW is loaded to a correspondingly limited extent, or not at all, such that the service life thereof is considerably extended. At the same time, reactive power compensation is undertaken by the converter CVAR, as shown in FIG. 11. In this case, it is advantageous that no other means, e.g. mechanical switches, are required for the isolation of the energy store, such that it can respond without delay.

If required, e.g. for the charging of the energy store or for the stabilization of the high-voltage network following a disturbance, the active power is controlled by the converter such that the take-up of energy from the high-voltage network or the injection of energy from the energy store into the network can be controlled by the control unit 9. In this case, reactive power is supplied by the converter CVAR as required, or may be zero. FIGS. 6-10 represent situations in which reactive power is supplied by the converter CVAR. FIG. 11 represents the situation in which the reactive power is zero.

The second of the above-mentioned problems, namely, an uncontrolled high charging current upon switching on, is resolved by the assembly 10, in that the current is limited by means of the converter CVAR, even where the voltage on the converter CW is smaller than the network voltage, or even zero, as in the exemplary embodiment represented in FIG. 11. The converter CVAR must only be designed for the reactive power, such that its capacitors are configured with a specified and appropriate capacitance for this purpose. Accordingly, upon start-up, the capacitors can be charged rapidly and with no overcurrent, without the requirement for any complex means for this purpose. Accordingly, the assembly 10 will be available immediately after switching on.

As the current can be effectively limited by the converter CVAR, a substantial margin of freedom is available in respect of the voltage on the converter CW and on the energy storage elements which are associated with said converter. Accordingly, the charging and discharging of the energy stores can proceed at any time, independently of the voltage, thereby permitting the maximum energy output. In this way, the third of the above-mentioned problems, namely, the dependence of the energy store upon the state of charge, can be eliminated. Moreover, the submodules of the converter can be of comparatively simple design as, conversely to the prior art, no chopper or similar component is necessary.

FIG. 12 shows an exemplary embodiment of an assembly 18 for compensating reactive power and active power, in which the converter CW is configured as a modular, multi-stage converter with submodules 16 comprised of H-bridges (full bridges). An H-bridge of this kind is characterized in that said bridge or its terminal voltage can assume three states (zero, positive or negative). In FIG. 12 it will be seen that, in place of a conventional d.c. capacitor, an energy storage element 17 is provided which, in the exemplary embodiment represented, is configured as a lithium-ion battery. Alternatively, the energy storage element might be a double-layer capacitor. Accordingly, the assembly 18 represented in FIG. 12 also embodies the principle of a series circuit of two converters, one of which is designed for the compensation of reactive power and the other of which is designed for the compensation of active power.

FIG. 13 shows a further exemplary embodiment with an assembly 19, in which the two three-phase converters CW and CVAR are configured as modular, multi-stage converters, whereby the complete assembly 19 comprises six terminals (X11, X12, X13, X41, X42, X43). The assembly 19 can therefore be configured either as a star-connected circuit or as a delta-connected circuit. Although, in FIG. 13, inductances 20 are represented between the two converters CW, CVAR, these are optional, and are not absolutely necessary. In FIG. 13 it will be seen that one submodule 16 of the converter CW comprises an energy storage element 17, in accordance with the exemplary embodiment shown in FIG. 12. On the other hand, one submodule 21 of the converter CVAR comprises a d.c. capacitor 22.

FIG. 14 shows a further exemplary embodiment, in which the two converters CW, CVAR are configured as modular, multi-stage converters, whereby CW is star-connected and CVAR is delta-connected. The inductances 23 in the assembly 24 are incorporated in the delta-connected circuit.

FIG. 15 shows an assembly 25 comprising a converter 26 for the compensation of reactive power and a converter 27 for the compensation of active power. In their design, the converters 26, 27 correspond to those represented in FIG. 13. The power semiconductor switches of the converters 26, 27 may be configured as IGBTs, IGCTs or GTOs.

In FIG. 15, it will be seen that a combination of antiparallel-connected thyristors 28 is connected in parallel to the converter 27 for the compensation of active power. During the output of reactive power, the thyristors 28 are continuously ignited, such that the energy storage cells (converter 27) are not actuated. In this state, the thyristors 28 bridge the converter 27 and, as a result, higher losses are avoided which would occur if current were to flow through the converter 27, because if that were the case the current path would always lead through an IGBT and a diode. Immediately when active power is to be delivered, the thyristors 28 are blocked, and the energy storage cells (converter 27) are actuated.

FIG. 16 shows a phase module 29, which is configured as a series circuit comprised of an inductance 30, a number of converters for the compensation of reactive power 26, and a number of converters for the compensation of active power 27.

The configuration of the assembly in FIG. 17 is similar to that represented in FIG. 16, and also incorporates antiparallel-connected thyristors 28 which are connected in series with a switching inductance 32. The thyristors 28 and the switching inductance 32 are connected in parallel with the converter 27 for the compensation of active power. In FIG. 17, it will be seen that the thyristors 28 are connected in an arrangement which is capable of bridging a number of energy stores or a number of converters 27. This is possible, as the thyristors 28 have a higher blocking voltage than the IGBTs of the converter 27.

Finally, FIG. 18 shows a phase module 33, in which the inductance 30 and the switching inductance 32 are replaced by a duplex choke device 34, which is connected with both the combination of interconnected thyristors 28 and the converters 27 for the compensation of active power, which are connected in series with the converters 26 for the compensation of reactive power. In accordance with the circuit represented in FIG. 17, the thyristors 28 in this case are also arranged or connected such that they bridge a number of converters 27, whereby for example the losses from six IGBTs and six diodes can be replaced by the losses from a single thyristor.

The various phase modules 29, 31 and 33 represented in FIGS. 16, 17 and 18 can be interconnected in a star-connected circuit or a delta-connected circuit.

FIGS. 19 to 22 represent corresponding applications, whereby FIG. 19 shows a circuit in which a number of phase modules 29 are interconnected in a delta-connected circuit.

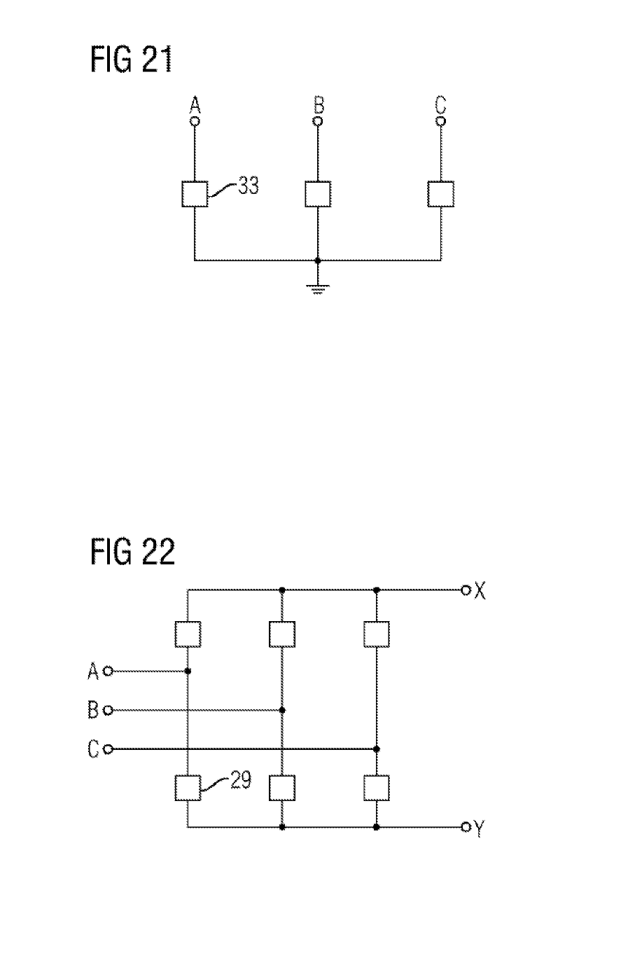

FIG. 20 shows an assembly of a number of phase modules 31 in the form of a star-connected circuit. FIG. 21 shows a further assembly of a number of phase modules 33. FIG. 22 shows a circuit arrangement of a number of phase modules 29, which is suitable for a HVDC (high-voltage direct current transmission) function.

Although the invention is illustrated and described in detail with reference to the preferred exemplary embodiment, the invention is not limited by the examples disclosed, and further variations may be deduced therefrom by a person skilled in the art, without departing from the scope of protection of the invention.

1-17. (canceled)

18. An assembly for compensating reactive power and active power in a high-voltage network, the assembly comprising:
a first converter configured for compensating the active power; and
a second converter configured for compensating the reactive power and connected in series with said first converter, whereby a voltage supply or output from the assembly corresponds to a sum of voltages of said first converter and said second converter.

19. The assembly according to claim 18, further comprising a control unit configured for measuring voltages and currents present on the high-voltage network, and for determining the voltages output from said first and second converters such that the active power and the reactive power are taken up from the high-voltage network or fed into the high-voltage network.

20. The assembly according to claim 19, wherein said first and second converters are controlled by said control unit, such that said first converter compensates the active power only, and said second converter compensates the reactive power only.

21. The assembly according to claim 18, wherein said first converter contains at least one energy storage element, or is connected to an energy store.

22. The assembly according to claim 21, wherein said energy storage element is formed as an element selected from the group consisting of a capacitor, a double-layer capacitor and a battery.

23. The assembly according to claim 18, wherein at least one of said first converter or said second converter contains a choke device.

24. The assembly according to claim 19, wherein said control unit is configured to control a voltage output of said first converter such that the voltage output is in phase with, or in phase opposition to a current flowing in said first converter.

25. The assembly according to claim 19, wherein said control unit controls said second converter such that a current flowing in said second converter is limited.

26. The assembly according to claim 18, wherein said first and second converters each contain at least one H-bridge.

27. The assembly according to claim 18, wherein said first converter is configured as a modular, multi-stage converter, and has at least two series-connected H-bridges with at least one energy storage element respectively.

28. The assembly according to claim 18, wherein said second converter is configured as a modular, multi-stage converter, and has at least two series-connected H-bridges with at least one capacitor respectively.

29. The assembly according to claim 26, wherein said H-bridge is configured of power semiconductor switches.

30. The assembly according to claim 26, further comprising anti-parallel-connected thyristors connected in parallel to said H-bridge of said first converter.

31. The assembly according to claim 26,
wherein said first converter has a plurality of series-connected H-bridges; and
further comprising switches for bridging said H-bridges of said first converter, whereby one of said switches bridges a number of said series-connected H-bridges.

32. The assembly according to claim 18, further comprising a switch for bridging of said first converter, whereby said switch is selected from the group consisting of a mechanical switch, a semiconductor switch, and a thyristor switch.

33. The assembly according to claim 18, wherein said first and second converters are each configured as three-phase devices.

34. The assembly according to claim 33, wherein said first and second converters are connected in a star-connected circuit or a delta-connected circuit.
